(19) United States
(12) Patent Application Publication
(10) Pub. No.: US 2002/0055822 A1
(43) Pub. Date: May 9, 2002

(54) Integrated welding and testing in the manufacture of smart cards

(76) Inventors: Paul Amadeo, San Diego, CA (US); Timothy Norman, San Diego, CA (US)

Correspondence Address: SCOTT C. HARRIS, Fish & Richardson P.C., Suite 500, 4350 La Jolla Village Drive, San Diego, CA, 92122, US

(21) Appl. No.: 09/919,716

(22) Filed: Jul. 31, 2001

Related U.S. Application Data
(60) Provisional application No. 60/247,413, filed on Nov. 8, 2000.

(51) Int. Cl. G01B 5/28; G01B 5/30; G06F 19/00

(52) U.S. Cl. 702/38

(57) ABSTRACT

In an embodiment, a weld head for use in bonding antennas to IC modules in a sheet of smart card modules includes an integrated test unit, e.g., a reader/writer (R/W) unit. The test unit tests the bonds between the antenna and the IC module in a selected card module by attempting to communicate with the IC module with low-wattage RF waves via the card module's antenna.

### CROSS-REFERENCE TO RELATED APPLICATIONS

This application claims priority to U.S. Provisional Application Serial No. 60/247,413, filed on Nov. 8, 2000 and entitled Integration of Smart Card Reader/Writers in High-Speed Robotic Welding Systems for On-the-Fly Quality Control Testing of Microelectronic Interconnects in the Manufacturing of Contactless Smart Cards.

### BACKGROUND

Smart cards are plastic cards that incorporate an integrated circuit (IC) chip with some form of memory. Many smart cards are wallet-sized, as specified by International Standard Organization (ISO) standards. These international standards specify physical characteristics of cards, transmission protocols, and rules for applications and data elements.

Memory-based smart cards include memory and some non-programmable logic. Such cards may be used as personal identification cards or phone cards. More complex processor-based smart cards may include a central processing unit (CPU) and ROM for storing an operating system, a main memory (RAM), and a memory section for storing application data (usually an EEPROM). Processor-based smart cards may be used where heavy calculations or more security is required.

Smart cards may fall into one of two categories: contact and contactless. Contact cards must be inserted into a card reader to be accessed. Contact cards include an interconnect module, usually gold plated, with contact pads. The interconnect module may include power, reset, ground, serial input/output (SIO), and clock signal contact pads, as laid out in ISO 7816. The contact pads are physically contacted by pins in the reader to power and communicate with the IC chip. Contact cards are commonly used as telephone prepayment cards and bank cards.

Contactless cards do not require contact with the reader to be accessed. Contactless cards include an antenna embedded in the card which may be used for power transmission and communication by radio signals or capacitive inductance. Some advantages of contactless cards over contact cards include faster transactions, ease of use, and less wear and tear on the cards and readers.

Hybrid and dual-interface cards include aspects of both contact and contactless cards. Hybrid cards have two chips, each with its respective contact and contactless interface. Dual-interface, or “combi,” cards have a single chip with both contact and contactless interfaces.

### SUMMARY

In an embodiment, the bonds between the antennas and integrated circuit (IC) modules in a batch of smart card modules formed in a sheet substrate are produced and tested by an integrated weld/test apparatus. The bonds are generated at one ore more interconnect sites in a card module with a weld tip and then tested with a test unit (e.g., a reader unit or reader/writer (R/W) unit) prior to the welding operation in the next selected card module in the sheet.

The test unit includes an antenna which generates electromagnetic waves, e.g., radio frequency (RF) waves, for powering and communicating with an IC module in a card module via the card module's antenna. The test unit may test the IC module by reading the contents of a memory in the IC module. The test unit may test the IC module by writing information to the IC module memory and then reading back that information via the antenna. The test unit may test the IC module by prompting a processor in the IC module to perform a function. A card module that fails testing may be marked for re-work.

An integrated R/W unit may be used to program the IC module in a selected card module in a sheet with initialization and/or personalization information after the weld operation in the selected card module and before the weld operation in the next selected card module in the sheet.

After the bonds in the card modules in the sheet have been welded and tested and any in line programming has been performed, the sheet may be cut into pre-tested and/or pre-programmed smart cards.

### BRIEF DESCRIPTION OF THE DRAWINGS

FIG. 1 is a sectional view of a smart card according to an embodiment.

FIG. 2A is a plan view of a sheet including a number of card modules according to an embodiment.

FIG. 2B is an expanded view of one of the card modules of FIG. 2A.

FIG. 3 is a perspective view of an integrated weld/test head according to an embodiment.

FIG. 4 is a flowchart describing an integrated weld and test operation according to an embodiment.

### DETAILED DESCRIPTION

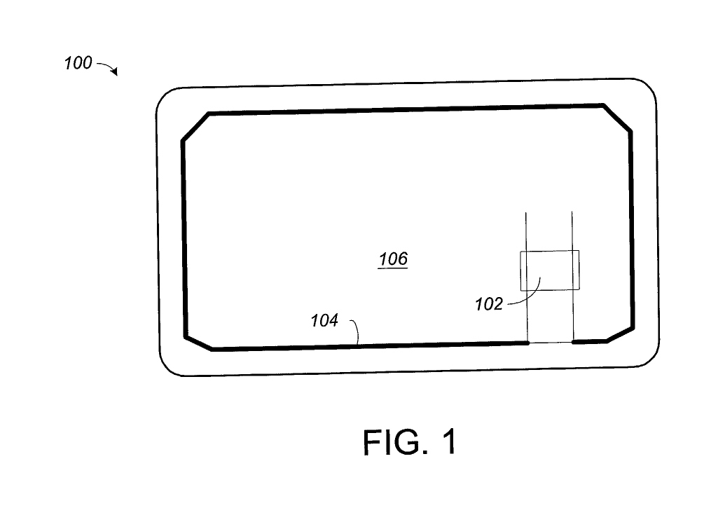

FIG. 1 illustrates a contactless smart card 100 according to an embodiment. The contactless card 100 contains an integrated circuit (IC) chip 102 connected to a wire-wound antenna 104 embedded in a plastic card layer 106. The antenna 104 may include three or four turns of wire and is generally located around the perimeter of the card. The card may conform to International Standard Organization (ISO) 14443 or 15693, an international standard for remote coupling contactless cards. ISO specifies physical, mechanical, and electrical features of the card and the communication protocols between the card and the reader, without restricting the architecture of the IC chip in the card or the application for the card. A popular architecture for such contactless smart cards is the Mifare architecture and related protocols developed by Philips Semiconductor.

Reader peripherals and reader/writer (R/W) units read contactless smart cards through low-wattage radio frequencies, generally between 10 MHz to 15 MHz. The readers produce a low-level magnetic field by means of a transmitting antenna, usually in the form of a coil. The magnetic field serves as a carrier of power from the reader to the contactless smart card, which accesses this field through the embedded antenna 104. The reader recovers the electromagnetic signal from the passive smart card and converts the signal back into an electrical form. Once the reader has checked for errors and validated the data received from the smart card, the data is decoded and restructured for transmission in the format required by the host computer.

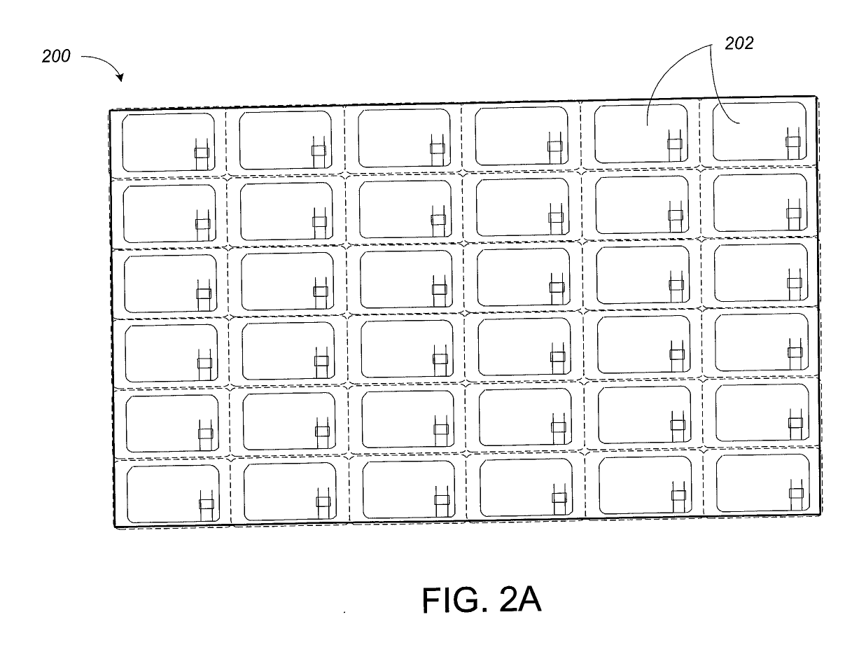

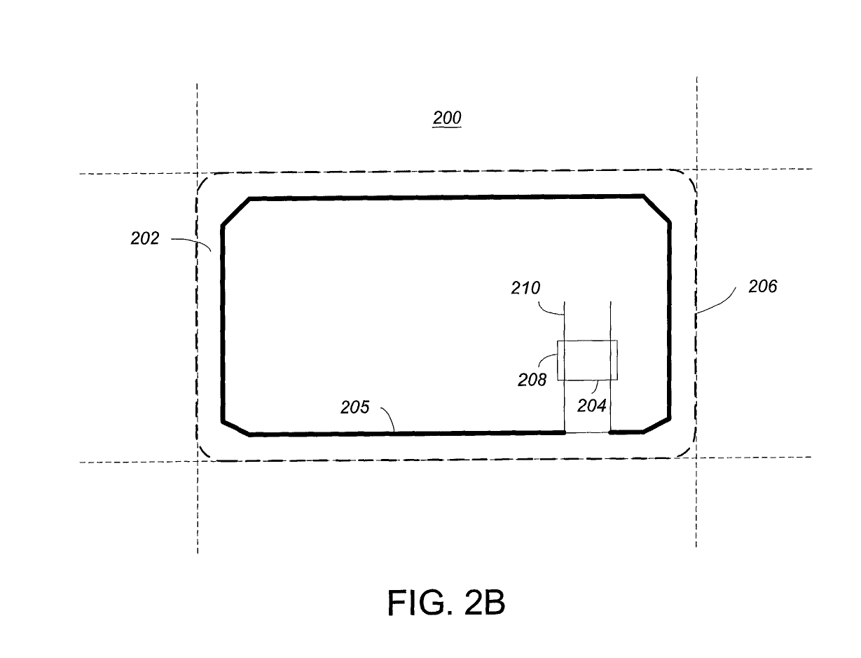

A batch of contactless smart cards may be manufactured simultaneously from a single sheet 200 of plastic, e.g., Polyvinyl Chloride (PVC) or Acrylonitrile Butadiene Styrene (ABS), as shown in FIGS. 2A and 2B. The plastic sheet 200 forms the substrate of the smart card modules 202 that are subsequently cut from the sheet 200. Cavities are punched in the sheet in locations corresponding to the IC modules for each card in the sheet. The IC modules 204 are then placed in the cavities and secured in place with an adhesive.

After the sheet has been populated with IC modules, the card antennas 204 are installed. The card antennas 204 may be round conductor wires that are embedded into the sheet 200 around what will be the perimeters 206 of the cut cards. A robotic arm that includes an ultrasonic head, a wire feed system, and cutter may be used to liquefy the plastic in the sheet and embed the wire antennas in the different card locations. Alternatively, the antennas may be bonded or deposited on the sheet in the respective card modules 202.

Each IC module 204 may include two contact tabs 208 for interconnection with the two ends 210 of the associated wound wire antenna 204 of the card module. The ends 210 of the wire antenna may be bonded to the contact tabs 208 using thermo-compression welding techniques. Since the wire antenna is used to supply power to the IC module and to enable the IC module to communicate with the card reader, it is critical that a good bond is formed between the wire antenna and the IC module.

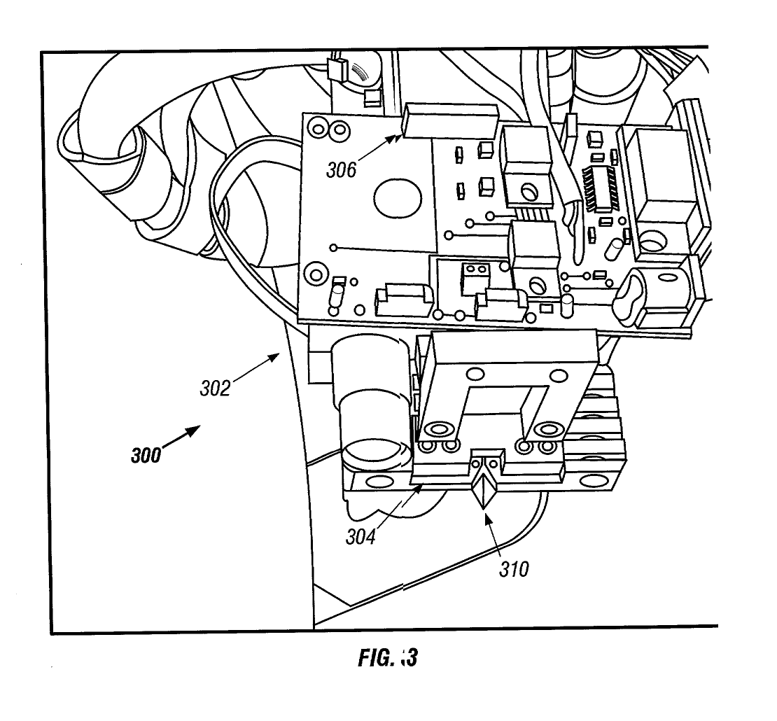

In an embodiment, the bonds between the antenna ends 210 and the IC module 204 are tested during fabrication of the card modules 202 in the sheet 200 (i.e., tested “in line”) by testing the operation of the IC module 204 via the wire antenna 205 following the interconnect welding operation. As shown in FIG. 3, the bonding apparatus 300 includes a robotic welding system with a robot hand 302 that integrates a weld head 304 and a R/W unit 306. The weld head 304 includes a weld tip 310 for producing the thermo-compression bond between the wire antenna ends 210 and the contact tabs 208 on the IC module 204. The R/W unit 306 generates low-wattage radio frequencies (e.g., between 10 MHz to 15 MHz) for providing power to and communicating with the IC modules 204 in the sheet 200 via the associated wire antennas 205 to which the IC modules 204 are connected.

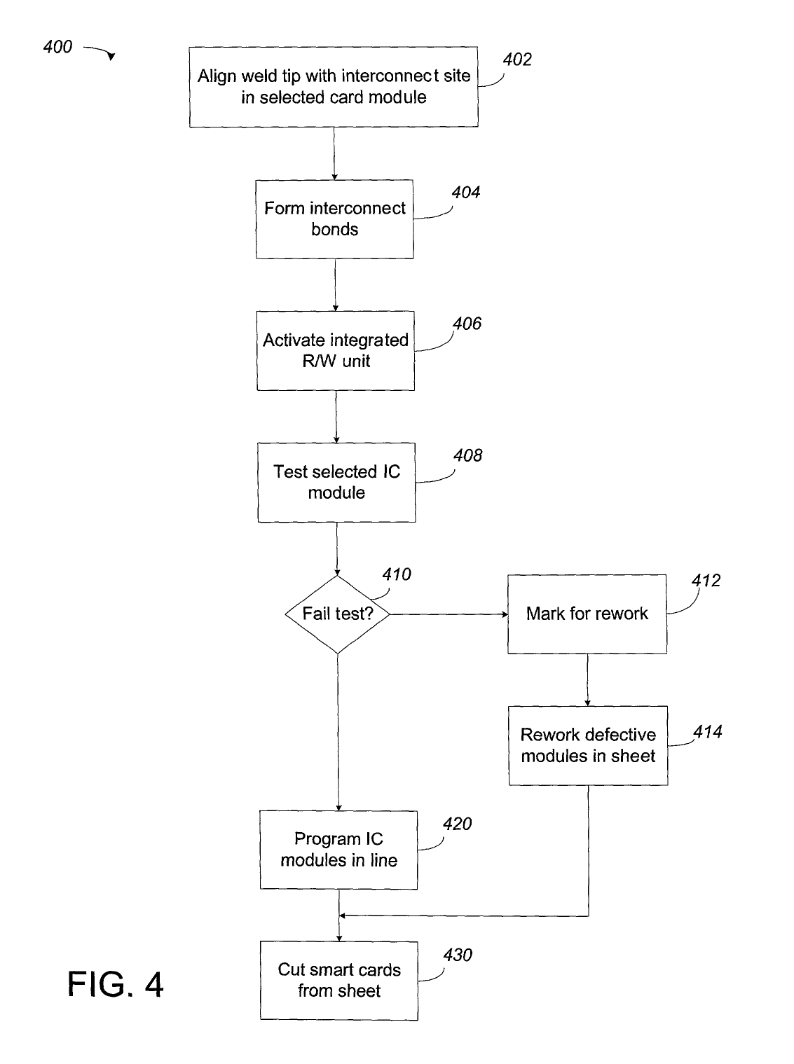

FIG. 4 is a flowchart illustrating an integrated weld and test operation 400 to an embodiment. The flow of the operation 400 is exemplary, and blocks in the flowchart may be skipped or performed in different order and still achieve desirable results.

The robot arm and/or sheet are moved to align the weld tip 310 with the interconnect site on an IC module 204 in a selected card module 202 (block 402). The heated weld tip 310 is pressed against the interconnect site to form the thermo-compression bond (block 404). After both interconnects are made between the wire ends 210 and contact tabs 208 of the IC module, the R/W unit 306 is activated (block 406). The robot arm may move the R/W unit 306 to a desirable range and orientation for communicating with the IC module 204, e.g., about 4 cm. The R/W unit 306 then tests the operation of the selected IC module (block 408).

The R/W unit 306 may perform one or more of various tests on the IC module. These tests may include, for example, a wake-up call, serial number check, full memory read, and full function test. The R/W unit 306 may also write data to the chip and then read back and check the written data from the chip memory. If any of the tests fail (block 410), the card may be stamped or otherwise marked for rework (block 412). After the weld and test operations have been performed on all of the card modules 202 in the sheet 200, the marked cards modules with defective interconnects may be reworked in a subsequent fabrication operation (414).

The IC modules 204 in the individual smart card modules 202 may also be programmed in line by the R/W unit 306 (block 420), before the cards are separated from the sheet. The programming may include initialization, in which all of the IC modules 204 are loaded with data that is the same for the batch of smart cards in the sheet 200. The programming may also include personalization, in which an individual IC module 204 is loaded with data specific to an individual cardholder.

When the interconnects in all of the card modules 202 on the sheet 200 are satisfactory and any desired in line programming of the IC modules 204 is complete, the sheet 200 may be passed on for lamination. Once laminated, the sheet 200 may be cut into the individual smart cards (block 430).

The operation 400 may be implemented in hardware or software, or a combination of both (e.g., programmable logic arrays). Unless otherwise specified, the algorithms included as part of the operation are not inherently related to any particular computer or other apparatus. In particular, various general purpose machines may be used with programs written in accordance with the teachings herein, or it may be more convenient to construct more specialized apparatus to perform the required method steps. However, preferably, the invention is implemented in one or more computer programs executing on programmable systems each comprising at least one processor, at least one data storage system (including volatile and non-volatile memory and/or storage elements), at least one input device, and at least one output device. Program code is applied to input data to perform the functions described herein and generate output information. The output information is applied to one or more output devices, in known fashion.

Each such program may be implemented in any desired computer language (including machine, assembly, high level procedural, or object oriented programming languages) to communicate with a computer system. In any case, the language may be a compiled or interpreted language.

Each such computer program is preferably stored on a storage media or device (e.g., ROM, CD-ROM, or magnetic or optical media) readable by a general or special purpose programmable computer, for configuring and operating the computer when the storage media or device is read by the computer to perform the procedures described herein. The system may also be considered to be implemented as a computer-readable storage medium, configured with a computer program, where the storage medium so configured causes a computer to operate in a specific and predefined manner to perform the functions described herein.

A number of embodiments have been described. Nevertheless, it will be understood that various modifications may be made without departing from the spirit and scope of the invention. Accordingly, other embodiments are within the scope of the following claims.

1. A method comprising:
selecting a card module in a sheet comprising a plurality of card modules, each card module including an integrated circuit (IC) module and an antenna;
bonding the antenna to the IC module in the selected card module at one or more interconnect sites; and
testing the bond at the one or more interconnect sites by communicating with the IC module via electromagnetic waves.

2. The method of claim 1, further comprising:
separating the selected card module from the sheet.

3. The method of claim 1, wherein the electromagnetic waves comprise radio frequency waves.

4. The method of claim 3, wherein the radio frequency waves have a frequency in a range between about 10 MHz and about 15 MHz.

5. The method of claim 1, wherein said testing the bond at the one or more interconnect sites comprises powering the IC module.

6. The method of claim 1, wherein the IC module comprises a memory, and wherein said communicating with the IC module comprises reading the contents of said memory.

7. The method of claim 6, wherein reading the contents of said memory comprises reading a serial number stored in the memory of the IC module.

8. The method of claim 6, wherein said communicating with the IC module comprises writing information to the memory.

9. The method of claim 1, wherein the IC module includes a processor operative to perform a function, and wherein said communicating with the IC module comprises prompting the processor to perform said function.

10. The method of claim 1, wherein the card module comprises a contactless smart card module.

11. A method comprising:
selecting a card module in a sheet comprising a plurality of card modules, each card module including an antenna and an integrated circuit (IC) module having a processor and a memory;
bonding the antenna to the IC module in the selected card module at one or more interconnect sites; and
programming the selected card module in the sheet via electromagnetic waves.

12. The method of claim 11, further comprising:
separating the selected card module from the sheet.

13. The method of claim 11, wherein said programming comprises initializing the processor in the selected card module with information associated with a plurality of other card modules in the sheet.

14. The method of claim 11, wherein said programming comprises personalizing the processor in the selected card module with information unique to the selected card module in the sheet.

15. The method of claim 14, wherein said information comprises personal information associated with a particular cardholder.

16. Apparatus comprising:
a weld head including a tip adapted to be heated; and
a smart card reader module connected to the weld head, said card reader including an antenna adapted to communicate with a smart card module via electromagnetic waves.

17. The apparatus of claim 16, wherein the smart card reader comprises a reader/writer unit.

18. The apparatus of claim 16, further comprising:
a processor operative to generate a bond between an integrated circuit (IC) module and an antenna in the smart card module and to test the bond by attempting to communicate with said smart card module.

19. The apparatus of claim 18, further comprising a marking device operative to mark the smart card module in response to the attempt to communicate with said smart card module failing.

20. The apparatus of claim 18, further comprising a memory device operative to store information to program smart card modules in a sheet,
wherein the processor is operative to transmit the stored information to the smart card module.

21. An sheet substrate comprising:
a first plurality of smart card modules, each of a second plurality of said first plurality of smart card modules including
an antenna including an antenna portion, and
an integrated circuit (IC) module including
an interconnect pad,
a bond between the interconnect pad and the antenna portion, and
a memory including information accessed via said antenna.

22. The sheet substrate of claim 21, wherein the memory in one of said second plurality of smart card modules includes information programmed via said antenna.

23. The sheet substrate of claim 22, wherein the information programmed via said antenna comprises initialization information.

24. The sheet substrate of claim 22, wherein the information programmed via said antenna comprises personalization information.

25. An article comprising a machine-readable medium which stores machine executable instructions, said instructions operative to cause a machine to:
select a card module in a sheet comprising a plurality of card modules, each card module including an integrated circuit (IC) module and an antenna;
bond the antenna to the IC module in the selected card module at one or more interconnect sites; and
test the bond at the one or more interconnect sites by communicating with the IC module via electromagnetic waves.

26. The method of claim 25, said instructions further comprising instructions operative to cause the machine to:
separate the selected card module from the sheet.

27. The article of claim 25, wherein the IC module comprises a memory, and wherein the instructions operative to cause the machine to communicate with the IC module further comprise instructions operative to cause the machine to read the contents of said memory.

28. The article of claim 27, wherein the instructions operative to cause the machine to communicate with the IC module further comprise instructions operative to cause the machine to write information to the memory.

29. The article of claim 25, wherein the IC module includes a processor operative to perform a function, and wherein the instructions operative to cause the machine to communicate with the IC module further comprise instructions operative to cause the machine to prompt the processor to perform said function.

30. An article comprising a machine-readable medium which stores machine executable instructions, said instructions operative to cause a machine to:
select a card module in a sheet comprising a plurality of card modules, each card module including an antenna and an integrated circuit (IC) module having a processor and a memory;
bond the antenna to the IC module in the selected card module at one or more interconnect sites; and
program the selected card module in the sheet via electromagnetic waves.

31. The article of claim 30, further comprising instructions operative to cause the machine to:
separate the selected card module from the sheet.

32. The article of claim 30, wherein the instructions operative to cause the machine to program comprises instructions operative to cause the machine to initialize the processor in the selected card module with information associated with a plurality of other card modules in the sheet.

33. The article of claim 30, wherein the instructions operative to cause the machine to program comprises instructions operative to cause the machine to personalize the processor in the selected card module with information unique to the selected card module in the sheet.
